(19) United States
(12) Patent Application Publication
(10) Pub. No.: US 2004/0099104 A1
(43) Pub. Date: May 27, 2004

(54) Drill bits

(76) Inventor: David Andrew Pearson, Hunt. Bch., CA (US)

Correspondence Address: DAVID PEARSON, 22102 CAPE MAY LANE, HUNTINGTON BEACH, CA, 92646, US

(21) Appl. No.: 10/300,373

(22) Filed: Nov. 21, 2002

(51) Int. Cl. B25B 13/56

(52) U.S. Cl. 81/176.15

(57) ABSTRACT

A device comprising a modification to the system of gears normally embodied as a keyless drill chuck Two (bit grabbing) protrusions (instead of three) are situated opposite each other The shape of each new part is two sides a symetrical three diminsional triangle with a sixty degree angle. Embodiments include such devices as an adjustable bolt driver or a bit for power screw drivers for a conversion to a power adjustable bolt driver. Also included is a (plastic) forked drill bit.

### FIELD

### Technical

This invention relates to power screw drivers.

### BRIEF SUMMARY

A drill bit designed for winding wind-up motors (or other wind-up apparatuses). Also included is an adjustable bit/driver designed for conventional six sided bolt heads. Predicted is a adjustable driver for screws with square holes. Also Predicted is a drill bit designed for dusting, a drill bit designed for mixing drinks and for use as a blender, a drill bit with a (circular) brush on the end of it and a drill bit designed for polishing Also predicted is a glow-in-the-dark (screw) driver and a (glow-in-the-dark) (foam) (rubber) (screw) driver grip.

### BRIEF DESCRIPTIONS OF THE DRAWINGS

FIGS. 1 and 2 are side views

FIG. 3 is an enlarged bottom cut-away view

FIG. 4 is a top view.

FIG. 5 is a bottom view.

FIG. 6 depicts a back cut-away see through view of part number 10 coupled with a front view of part number 2.

### DETAILED DESCRIPTIONS

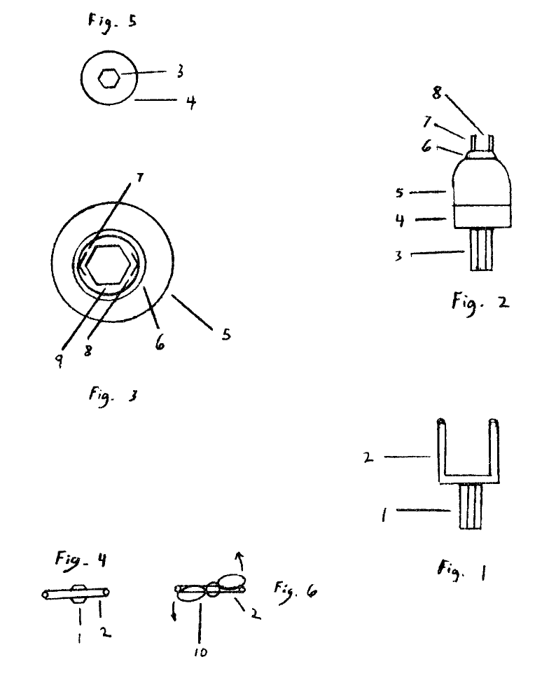

FIGS. 1 and 4 illustrate the propeller bit. It is a (power screwdriver) bit designed for winding (rubber band powered) (toy) airplanes Other shapes can be used for the propeller bit. FIG. 6 illustrates the propeller adaptor 2 winding a propeller. Other (drill) bits for winding different types of wind-up apparatuses are predicted. FIGS. 2, 3 and 5 illustrate the adjustable socket bit/driver. Size, shape and embodiments for the device can be subject to change. It is illustrated in an embodiment in which it is both an adjustable drill bit for bolts and an adjustable bolt driver. It is designed using a system of gears such as that of the conventional keyless chuck (bit recepticle) of a hand held power drill. A modification is included; It contains two (bit grabbing) protrusions 7 and 8 (instead of three, as is normally the case with such bit recepticles). Each protrusion is of a symetrical shape containing two sides of a three dimentional triangle with a sixty degree angle. The angle is subject to change or subtractable [for an embodiment in which they have flat (toothed) surfaces]. The modified protrusions are situated opposite each other and come together or move apart (in a line) depending on the direction that the dial 5 is rotated. The device is designed to work with raised bolt heads with two or more opposing sixty degree angles and nuts that are within its size range. It is expected that it can be designed to work with other types of hardware. An example is to change the shape of the bolt elements so that they have three dimentional triangles with ninty degree corners facing the exterior. The dial can be rotated so that the bolt elements touch two opposite corners of a screw with a square hole. The size of the bolt heads would be small enough so that they would both fit inside of the hole before the dial is turned to situate the bolt heads into the corners. Such a device would work as an adjustable apparatus for such screws.

Related to the drill bits are predicted concepts; a bit for hand held power drills and the like that is designed for dusting, a bit for such devices that is designed for polishing and a such a bit with a brush on the end of it Related to the adjustable bolt driver is another predicted concept; (screw) drivers with handles or other parts that glow in the dark and screw driver grips.

1. Screw driver adaptor can be a conventional adaptor for hand held power drills and the like.

2. Propeller adaptor can be an adapter. It can be placed on the propeller of a rubberband powered toy airplane and the power screwdriver can be energized to spin the propeller to wind the rubberband The screw driver adaptor and the propeller adaptor can be a singular piece of plastic. Material is subject to change. It is expected that the propeller bit can be packaged with rubberband powered toy airplanes or sold separately. It is expected that such an adapter can be designed to work with (any) contraption with one or more (motorized) elements/parts that can rotate. Other uses for forked bits are predicted.

3. Second driver adaptor can be a conventional adaptor for hand held power drills and the like. For another embodiment of the device as an adjustable bolt driver this part can be subtractable. Expected is a (hydrid) embodiment in which the device has a conventional square hole for socket wrenches. The type of wrench or apparatus for which it is designed as an adjustable socket would be subject to change.

4. Handle can be a handle. It is the stationary part of a keyless chuck that is held in place while the bit grabber dial 5 is spun to grab a bit. For the new apparatus it is held in place while the bit grabber dial is spun to fit a (six sided) bolt bolt head. For another embodiment of the device as an adjustable bolt driver this part can be much longer In an expected embodiment of the adjustable socket bit/driver (as a bolt driver) (the drill adaptor is removed and) the device is (longer and) of a smaller diameter (narrower for embodiments that are not circular) The size for all embodiments is subject to change. The expected diameter size for all embodiments can be smaller than the illustrated embodiment.

5. Dial can be a dial. It can be the part of the the system of gears that normally is the dial of a keyless chuck. It can be rotated to adjust the positioning of the bolt elements 7 and 8.

6. Circular element can be the part of the system of gears (or a keyless chuck) that the protusions slide outward or inward on as the dial is rotated

7. First bolt element can be one of the parts of the system of gears that is normally a bit grabbing protrusion on a conventional keyless chuck.

8. Second bolt element can be one of the parts of the system of gears that is normally a bit grabbing protrusion on a conventional keyless chuck. The bolt elements are firmly held in place as are the bit grabbing protrusions of a conventional keyless chuck. The size (thickness) and shape of the bolt elements is subject to change.

9. Bolt head can be a conventional bolt head. In FIG. 3 the dial can be rotated until the bolt elements contact the bolt head: At that point the adjustable socket/driver can act as a fitting socket or bolt driver for the bolt head.

10. Propeller can be a (colored) (clear) (glow-in-the-dark) propeller of a rubber band powered (toy) airplane. In FIG. 6 the propeller adaptor is being spun by a power screw driver (not shown) to wind (spin) the propeller. Predicted are (other) (plastic) parts for (toy) airplanes (and the like) that glow in the dark.

1. Bits for hand held power drills and the like that are designed for winding rubberband powered airplanes.

2. Forked bits for hand held power drills and the like.

3. Plastic bits for hand held power drills and the like.

4. The adjustable bolt driver as described here-in

5. The adjustable bolt adaptor for power drills and the like as described here-in.
